(19) United States
(12) Patent Application Publication
(10) Pub. No.: US 2020/0393248 A1
(43) Pub. Date: Dec. 17, 2020

(54) Method, Apparatus And Computer Program Product For Generating Indoor Maps

(71) Applicant: HERE Global B.V., Eindhoven (NL)

(72) Inventors: Muhammad Irshan Khan, Tampere (FI); Jani Kappi, Tampere (FI)

(21) Appl. No.: 16/441,246

(22) Filed: Jun. 14, 2019

(51) Int. Cl. G01C 21/00; G01C 21/20; G01S 5/02; G06F 16/29

(52) U.S. Cl. CPC G01C 21/005; G06F 16/29; G01S 5/0231; G01C 21/206

(57) ABSTRACT

A method, apparatus, and computer program product are provided for generating an indoor map of an area. The method includes receiving location information from a positioning system configured to determine the position of one or more components within the area. The method also includes generating an overview map defining one or more boundaries of the area. The method further includes receiving map creation information from a map creation asset configured to designate at least a subset of the area as a specific type of room. The method still further includes generating the indoor map of the area based on the overview map and the map creation information. The method further includes receiving room configuration information based on a prompt. The method still further includes updating the indoor map of the area based on the room configuration information. Corresponding apparatus and computer program product are provided.

### TECHNOLOGICAL FIELD

An example embodiment relates generally to map generation and, more particularly, to map generation for indoor areas.

### BACKGROUND

Indoor positioning requires systems and technology that are specifically developed and deployed for this purpose. Traditional positioning technologies used for outdoor mapping, such as satellite and cellular positioning systems, may perform poorly when used for indoor mapping resulting in incomplete and/or incorrect indoor mapping. Current technologies may not be able to provide positioning accuracy (e.g., 2-3 meters), coverage (e.g., close to 100%) and floor detection necessary to generate accurate indoor maps as the systems and technology were not designed for the indoor use case. For example, satellite-based radio navigation signals may not penetrate sufficiently through walls and/or roofs for the adequate signal reception, while cellular signal bands may be too narrow for accurate ranging in an indoor facility.

### BRIEF SUMMARY

A method, apparatus and computer program product are provided in accordance with an example embodiment in order to generate maps for indoor areas. In an example embodiment, a method is provided for generating an indoor map of an area. The method includes receiving location information from a positioning system configured to determine a position of one or more components within the area. The method also includes generating an overview map of the area. The overview map defines one or more boundaries of the area. The method further includes receiving map creation information from a map creation asset configured to designate at least a subset of the area as a specific type of room. The method still further includes generating the indoor map of the area based on the overview map and the map creation information.

In some embodiments, the method also includes causing the transmission of a prompt for room configuration information based on the specific type of room; receiving room configuration information based on the prompt; and updating the indoor map of the area based on the room configuration information. In some embodiments, the positioning system includes one or more ultra-wide band beacons configured to provide for radio-based positioning. In some embodiments, one of the one or more ultra-wide band beacons is designated as a primary beacon from which the coordinates of the one or more ultra-wide beacons are based. In some embodiments, the method also includes receiving a vertical dimension location of the beacon from at least one of a user input or a barometer and correlating map creation information and the overview map based on the vertical dimension location of the beacon.

In some embodiments, the map creation information includes voice assistance information. In some embodiments, the positioning system includes at least one of a global navigation satellite system, a radio-based positioning, a camera-based system, or a hand drawing.

In another example embodiment, an apparatus is provided for generating an indoor map of an area. The apparatus includes at least one processor and at least one non-transitory memory including computer program code instructions with the computer program code instructions configured to, when executed, cause the apparatus to receive location information from a positioning system configured to determine a position of one or more components within the area. The computer program instructions are also configured to, when executed, cause the apparatus to generate an overview map of the area. The overview map defines one or more boundaries of the area. The computer program instructions are further configured to, when executed, cause the apparatus to receive map creation information from a map creation asset configured to designate at least a subset of the area as a specific type of room. The computer program instructions are further configured to, when executed, cause the apparatus to generate the indoor map of the area based on the overview map and the map creation information.

In some embodiments, the computer program instructions are further configured to, when executed, cause the apparatus to cause the transmission of a prompt for room configuration information based on the specific type of room; receive room configuration information based on the prompt; and update the indoor map of the area based on the room configuration information. In some embodiments, the positioning system includes one or more ultra-wide band beacons configured to provide radio-based positioning.

In some embodiments, one of the one or more ultra-wide band beacons is designated as a primary beacon from which the coordinates of the one or more ultra-wide beacons are based. In some embodiments, the computer program instructions are further configured to, when executed, cause the apparatus to receive vertical dimension location of the beacon from at least one of a user input or a barometer and correlate map creation information and the overview map based on the vertical dimension location of the beacon.

In some embodiments, the map creation information includes voice assistance information. In some embodiments, the positioning system includes at least one of a global navigation satellite system, a radio-based positioning, a camera-based system, or a hand drawing.

In yet another example embodiment, a computer program product is provided that includes at least one non-transitory computer-readable storage medium having computer-executable program code portions stored therein with the computer-executable program code portions comprising program code instructions configured to receive location information from a positioning system configured to determine a position of one or more components within the area. The computer-executable program code portions also include program code instructions configured to generate an overview map of the area. The overview map defines one or more boundaries of the area. The computer-executable program code portions further include program code instructions configured to receive map creation information from a map creation asset configured to designate a subset of the area as a specific type of room. The computer-executable program code portions still further include program code instructions configured to generate the indoor map of the area based on the overview map and the map creation information.

In some embodiments, the program code instructions are further configured to cause the transmission of a prompt for room configuration information based on the specific type of room; receive room configuration information based on the prompt; and update the indoor map of the area based on the room configuration information. In some embodiments, the positioning system includes one or more ultra-wide band beacons configured to provide radio-based positioning. In some embodiments, the program code instructions are further configured to receive vertical dimension location of the beacon from at least one of a user input or a barometer and correlate map creation information and the overview map based on the vertical dimension location of the beacon.

In some embodiments, the map creation information includes voice assistance information. In some embodiments, the positioning system includes at least one of a global navigation satellite system, a radio-based positioning, a camera-based system, or a hand drawing.

In still another example embodiment, an apparatus is provided for generating an indoor map of an area. The apparatus includes means for receiving location information from a positioning system configured to determine a position of one or more components within the area. The apparatus also includes means for generating an overview map of the area. The overview map defines one or more boundaries of the area. The apparatus further includes means for receiving map creation information from a map creation asset configured to designate at least a subset of the area as a specific type of room. The apparatus still further includes means for generating the indoor map of the area based on the overview map and the map creation information.

In some embodiments, the apparatus also includes means for causing the transmission of a prompt for room configuration information based on the specific type of room; receiving room configuration information based on the prompt; and updating the indoor map of the area based on the room configuration information. In some embodiments, the positioning system includes one or more ultra-wide band beacons configured to provide for radio-based positioning. In some embodiments, one of the one or more ultra-wide band beacons is designated as a primary beacon from which the coordinates of the one or more ultra-wide beacons are based. In some embodiments, the apparatus also includes means for receiving a vertical dimension location of the beacon from at least one of a user input or a barometer and correlating map creation information and the overview map based on the vertical dimension location of the beacon.

In some embodiments, the map creation information includes voice assistance information. In some embodiments, the positioning system includes at least one of a global navigation satellite system, a radio-based positioning, a camera-based system, or a hand drawing.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a block diagram of an apparatus that may be specifically configured in accordance with an example embodiment of the present disclosure;

FIG. 2 is a flowchart illustrating the operations of an example embodiment in accordance with the present disclosure;

FIG. 3 is an example configuration of a positioning system based on an example embodiment of the present disclosure;

FIG. 4 illustrates an example method of the map generation process based on an example embodiment of the present disclosure; and

FIG. 5 is an example indoor map generated in accordance with an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Several positioning techniques have been designed or adapted for indoor map generation, such as pseudolites (global positioning system (GPS)-like short-range beacons), Bluetooth Low-energy (BTLE) signals, and Wi-Fi fingerprinting, have been created. These techniques require either deployment of totally new infrastructure (e.g., beacons, tags, or the like) or manual exhaustive radio-surveying of the buildings including all the floors, spaces and rooms. For example, BTLE and Wi-Fi requires location to be set manually by a user. Therefore, implementation may be relatively expensive and may take considerable time to build the coverage to a commercially expected level. Additionally, the diversity of these technologies make it difficult to build a globally scalable indoor positioning solution, and the integration and testing will become complex if a large number of technologies must be supported by the consumer devices, such as smartphones. As a result, the method, apparatus and computer program product of an example embodiment provide an indoor mapping solution that is globally scalable, requires low maintenance and deployment costs, and offers acceptable end-user experience.

The method, apparatus and computer program product of an example embodiment employ radio-based indoor positioning that develops models (e.g., of a Wi-Fi radio environment or any similar radio, such as Bluetooth, environment) from observed Received Signal Strength (RSS)-measurements in the form of radio maps, such as two-dimensional radio maps. The method, apparatus and computer program product of an example embodiment are able to capture the dynamics of the indoor radio propagation environment in a compressible and highly accurate way. In an example embodiment, to the method, apparatus and computer program product achieve high horizontal positioning accuracy with the Wi-Fi signals only within the coverage of the created radio maps while also providing highly reliable floor detection. In an example embodiment, huge volumes of indoor map creation information may be harvested via crowd-sourcing which, in turn, enables the creation of robust maps in reliance upon the crowd sourced information.

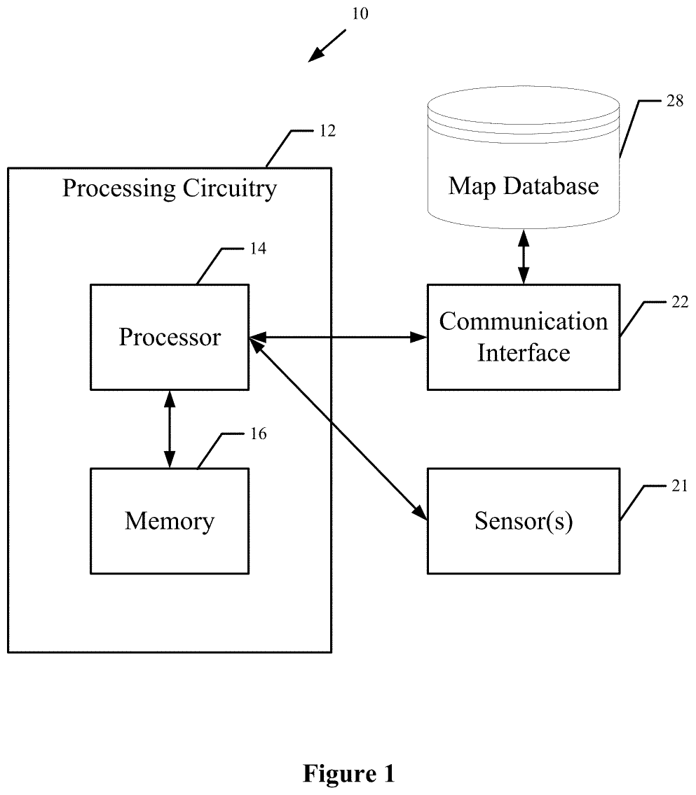

FIG. 1 is a schematic diagram of an example apparatus configured for performing any of the operations described herein. Apparatus 10 is an example embodiment that may be embodied by or associated with any of a variety of computing devices that include or are otherwise associated with a device configured for generating indoor maps. Certain embodiments described herein may be used for map generation, map updating, and map accuracy confirmation. Various embodiments of the apparatus may be embodied or partially embodied as a mobile terminal, such as a personal digital assistant (PDA), mobile telephone, smart phone, personal navigation device, smart watch, tablet computer, camera or any combination of the aforementioned and other types of voice and text communications systems. Alternatively, the apparatus may be embodied by a fixed computing device, such as a server, a computer workstation or the like. Optionally, the apparatus may be embodied by or associated with a plurality of computing devices that are in communication with or otherwise networked with one another such that the various functions performed by the apparatus may be divided between the plurality of computing devices that operate in collaboration with one another.

The apparatus 10 may include, be associated with, or may otherwise be in communication with a processing circuitry 12, such as a processor 14 and a memory device 16; a communication interface 22; a map database 28; and one or more sensors 21. In some embodiments, the processor 14 (and/or co-processors or any other processing circuitry assisting or otherwise associated with the processor) may be in communication with the memory device 16 via a bus for passing information among components of the apparatus. The memory device 16 may be non-transitory and may include, for example, one or more volatile and/or non-volatile memories. In other words, for example, the memory device 16 may be an electronic storage device (for example, a computer readable storage medium) comprising gates configured to store data (for example, bits) that may be retrievable by a machine (for example, a computing device such as the processor 14). The memory device 16 may be configured to store information, data, content, applications, instructions, or the like for enabling the apparatus 10 to carry out various functions in accordance with an example embodiment of the present invention. For example, the memory device 16 could be configured to buffer input data for processing by the processor 14. Additionally or alternatively, the memory device 16 could be configured to store instructions for execution by the processor 14.

The processor 14 may be embodied in a number of different ways. For example, the processor 14 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 14 may include one or more processing cores configured to perform independently. A multi-core processor may enable multiprocessing within a single physical package. Additionally or alternatively, the processor 14 may include one or more processors configured in tandem via the bus to enable independent execution of instructions, pipelining and/or multithreading.

In an example embodiment, the processor 14 may be configured to execute instructions stored in the memory device 16 or otherwise accessible to the processor. Alternatively or additionally, the processor 14 may be configured to execute hard coded functionality. As such, whether configured by hardware or software methods, or by a combination thereof, the processor 14 may represent an entity (for example, physically embodied in circuitry) capable of performing operations according to an embodiment of the present invention while configured accordingly. Thus, for example, when the processor 14 is embodied as an ASIC, FPGA or the like, the processor 14 may be specifically configured hardware for conducting the operations described herein. Alternatively, as another example, when the processor 14 is embodied as an executor of software instructions, the instructions may specifically configure the processor to perform the algorithms and/or operations described herein when the instructions are executed. However, in some cases, the processor 14 may be a processor of a specific device (for example, the computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor. In some embodiments, the processor 14 may be configured to use machine learning or other operations described herein.

The apparatus 10 of an example embodiment may also include a communication interface 22 that may be any means such as a device or circuitry embodied in either hardware or a combination of hardware and software that is configured to receive and/or transmit data from/to other electronic devices in communication with the apparatus, such as by NFC, described above. Additionally or alternatively, the communication interface 22 may be configured to communicate over Global System for Mobile Communications (GSM), such as but not limited to Long Term Evolution (LTE). In this regard, the communication interface 22 may include, for example, an antenna (or multiple antennas) and supporting hardware and/or software for enabling communications with a wireless communication network. Additionally or alternatively, the communication interface 22 may include the circuitry for interacting with the antenna(s) to cause transmission of signals via the antenna(s) or to handle receipt of signals received via the antenna(s). In some environments, the communication interface 22 may alternatively or also support wired communication and/or infrastructure wireless links. The communication interface 22 may be configured to communicate, through various methods described herein, with one or more sensors, user devices (e.g., mobile devices, computers, or the like), and/or the like.

The apparatus may be equipped or associated with a map database 28. In some embodiments, some or all of the map database 28 may be stored in the memory device 16. Additionally or alternatively, some or all of the map database 28 may be remote from the processing circuitry 12 and may be received by the processing circuitry 12, such as through the communication interface 22. The map database 28 may include information relating to room types, room configuration, and/or the like. The room type information may include information, such as common room types, common room sizes, common floor plans, and/or the like. The information relating to room configuration may include, common fixtures, furniture in a specific room type, typical wall geometrical coordinates, and/or the like.

In some embodiments, the apparatus 10 may be in communication with any number of sensors 21, such as a global positioning system (GPS) sensor, an accelerometer, a light detection and ranging (LiDAR) sensor, radar, an ultra-wide band (UWB) beacon, and/or a gyroscope. Any of the sensors may be used to sense information regarding the movement, positioning, or orientation of the positioning position and associated devices, such as mobile devices. The sensor(s) 21 may communicate with the apparatus 10, such as through communication interface 22 or the processor 14.

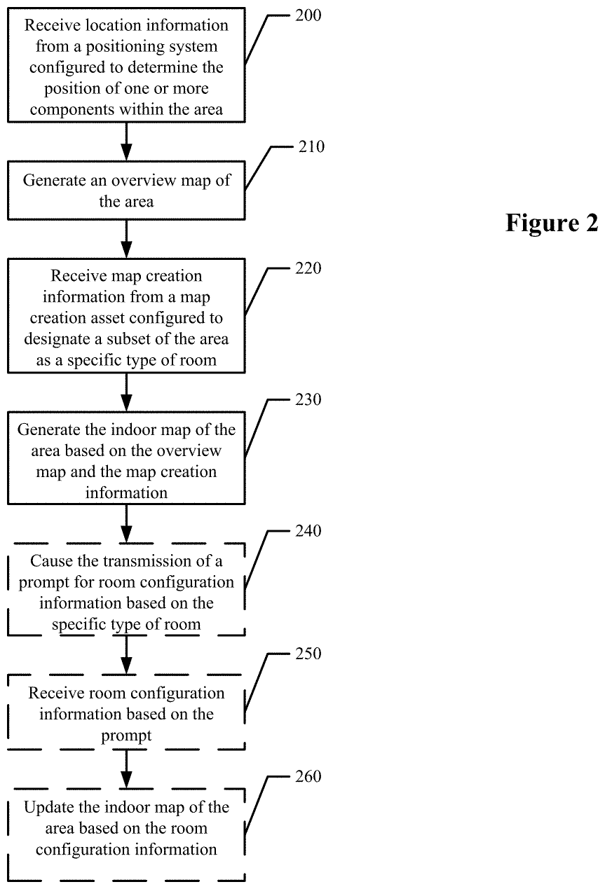

Referring now to FIG. 2, the apparatus 10 includes means, such as the communication interface 22, the processing circuitry 12, the processor 14, or the like for determining an indoor map. In various embodiments, the apparatus 10 discussed in FIG. 1 may be capable of some or all of the various operations shown in FIG. 2. In some embodiments, the apparatus 10 may employ voice assistance.

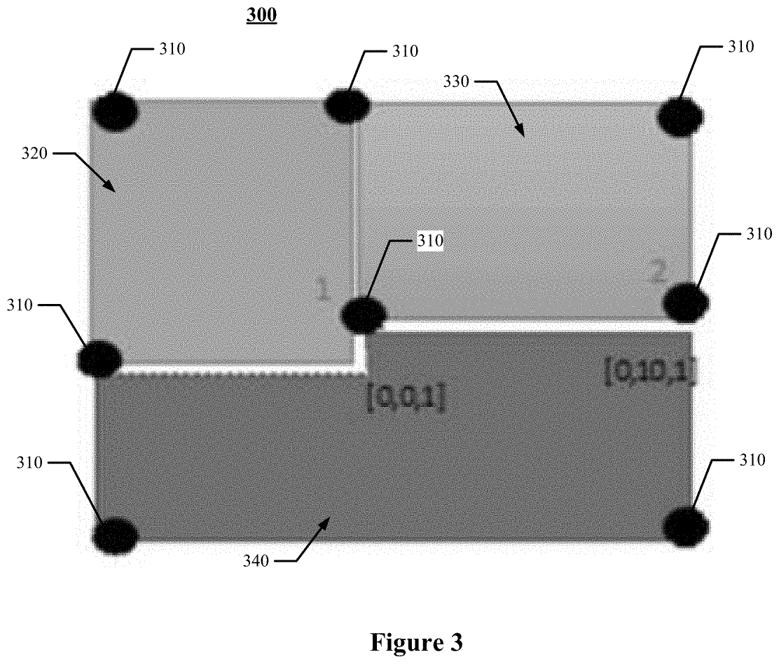

Referring to Block 200 of FIG. 2, the apparatus 10 includes means, such as the communication interface 20, the processing circuitry 12, the processor 14, or the like, for receiving location information from a positioning system that is configured to determine the position of one or more components of the positioning system within an area, that is, an indoor area, for which a map is to be generated. In some embodiments, the apparatus 10 may be in communication with a positioning system preexisting in an area. Alternatively, the user may set up a positioning system purely for the purpose of the apparatus described herein. In some embodiments, the positioning system may include a global navigation satellite system, a radio-based positioning system, a camera-based system, and/or a hand or computer-aided drawing. In various embodiments, the components may be part of the positioning system that are configured to provide location information for all or a portion of the area and may include beacons, such as UWB beacons. As shown in FIG. 3, in an example embodiment, one or more positioning beacons 310 (e.g., UWB beacons) may be placed in an indoor area 300, such along one or more walls of the area. In some embodiments, one or more of the positioning beacons 310 may be designated as a primary beacon. In some embodiments, the apparatus 10 includes means, such as the processing circuitry 12, e.g., the processor 14, for determining the position of the one or more positioning beacons and other devices in the area (e.g., mobile devices) that are configured to provide location information relative to the one or more primary beacons. For example, the apparatus 10 may use a coordinate system with the primary beacon location being the origin and the location of the other beacons being defined relative to said primary beacon location. In some embodiments, the one or more positioning beacons 310 (e.g., UWB beacons) may indicate the geometry of an area.

In some embodiments, the apparatus 10 includes means, such as the processing circuitry 12, e.g., the processor 14, for determining vertical positions within the area being mapped. For example, in multi-story buildings, the vertical position of the beacons may be used to determine whether map creation information should be used for a given area (e.g., the beacon may be located on the second floor of a building and would only be used in determining the indoor map for an area that included some or all of the second floor and not for indoor maps for areas that did not include some or all of the second floor). Additionally or alternatively, the vertical position may be used to determine the height of fixtures or furniture in the area (e.g., the height of a counter may be indicated by the height of a mobile device). In some embodiments, the apparatus 10 may include a coordinate system with the height incorporated to effectively generate a map for an area. In some embodiments, the vertical positioning of the beacons may be used in map generation of multi-story buildings. For example, global navigation satellite systems (GNSS) altitude may be used to determine the vertical coordinates. A coordinate system incorporating a vertical height may be relative to a primary beacon discussed above. In some embodiments, the height of the beacon may be determined using a barometer. In some embodiments, the height of the beacon may be determined by a user input.

Referring now to Block 210 of FIG. 2, the apparatus includes means, such as the processing circuitry 12, the processor 14, or the like, for generating an overview map of the area. In various embodiments, the overview map may be an initial version of the indoor map generated by the apparatus 10, such as by the processing circuitry 12, e.g., the processor 14, based on the information initially received from the positioning system. In some embodiments, the apparatus 10 includes means, such as the processing circuitry 12, e.g., the processor 14, for determining the exterior walls of the area to be mapped. For example, the beacons 310 may be placed along the exterior walls of the area to be mapped. In some embodiments, apparatus 10 includes means, such as the processor 14, for determining initial room information within an indoor area as indicated by the positioning system (e.g., beacons 310). For example, as shown in FIG. 3, beacons 310 may be positioned such that the apparatus 10, such as the processing circuitry 12, determines that the area has three rooms (e.g., rooms 320, 330, and 340). The initial room information may include the number of rooms in an area, the size of one or more rooms in the area, or the like.

In some embodiments, the overview map may be configured based on information received by the apparatus 10 other than the location information. For example, the apparatus 10 may include means, such as the communication interface 22, the processing circuitry 12, the processor 14, or the like, for receiving building information for an area. In some embodiments, the building information may include information about one or more areas in a building, such as the exterior shape, exterior size, and/or any walls. For example, the apparatus 10, such as the processing circuitry 12, may determine the overview map based on the exterior shape of the building if the area is an entire floor in the building.

Referring now to Block 220 of FIG. 2, the apparatus 10 includes means, such as the processing circuitry 12, the processor 14, or the like, for receiving map creation information from a map creation asset configured to designate at least a subset of the area as a specific type of room. In various embodiments, the map creation asset may be a user mobile device associated with a user and/or the map database 28 that stores information regarding the area for which a map is to be generated. In some embodiments, the map creation asset may respond to voice commands from a user. For example, the user may vocally provide the map creation information to the apparatus 10, either directly or through a mobile device. In some embodiments, the map creation information may include information relating to one or more rooms within an area. In some embodiments, the map creation information may include room type (e.g. kitchen, living room, bedroom, bathroom, or the like), room size, or the like. In various embodiments, the positioning of the user may be determined based on the positioning system. In some embodiments, the sound of the user's voice may be used to determine the location of the user within the area. Additionally or alternatively, the user may have a mobile device, such as a cell phone, in communication with the positioning system with the location of the mobile device, such as defined by the GPS coordinates of the mobile device, being utilized to determine the location of the user at the time map creation information is provided. For example, the apparatus 10 may receive location information from a mobile device that serves to locate various elements of the area that are defined by the map creation information. In some embodiments, verbal indications that are received by the apparatus 10may include requesting the apparatus 10 to begin generating an indoor map, providing a room type, providing dimensions of the room from a user, providing various room configuration details, and/or the like. For example, the user may verbally indicate that the user is standing in the kitchen, that the kitchen is 10 feet by 10 feet, and the refrigerator is on a specific wall.

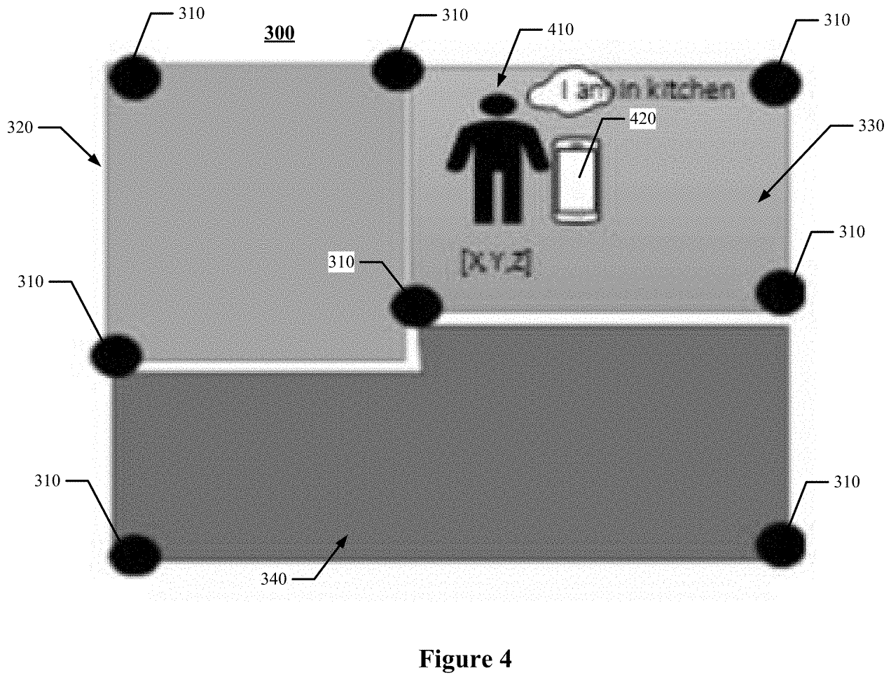

An example is shown in FIG. 4 of a user providing map creation information to the apparatus 10. For example, the user 410 may stand in a room within the indoor area for which a map is to be generated. In some embodiments, the user may carry or otherwise be in proximity with a mobile device 420. In an example embodiment, the user may provide the map creation information. In some embodiments, the map creation information may be a verbal indication provided by the user. Additionally or alternatively, the user may input map creation information into a mobile device in communication with the apparatus. For example, the apparatus 10 may be configured to provide an application on a mobile device that assists a user in inputting map creation information and the apparatus 10 may provide potential options for a room name and/or size (e.g., a user may say, “This is the kitchen” and the apparatus 10 may provide options of typical kitchen sizes for the user to select). In some embodiments, the apparatus 10 may include means, such as the processing circuitry 12, e.g., the processor 14, for determining the room type based on the map creation information. In some embodiments, the apparatus 10, such as the memory device 16, may have a plurality of common room types (e.g. kitchen, living room, bedroom, bathroom, or the like) stored that may be referenced based on the map creation information to determine a room type for a given room. In some embodiments, the apparatus 10 may provide a confirmation of room type based map creation information. In some embodiments, the apparatus 10 may have a standard procedure when a room type cannot be determined based on the map creation information. For example, the apparatus 10 may ask for the map creation information to be repeated (e.g., the original voice indication by a user may be unclear) and/or the apparatus 10 may allow a new room type to be entered (e.g., the room type may have a specific name, such as “North Conference Room”).

Referring now to Block 230 of FIG. 2, the apparatus 10 includes means, such as the processing circuitry 12, the processor 14, or the like, for generating the indoor map of the area based on the overview map and the map creation information. In some embodiments, the indoor map may be a more detailed version of the overview map (e.g., including room types and/or sizes). In some embodiments, the indoor map includes the room type information for one or more rooms in the area. As discussed below in reference to Blocks 240 through 260, the indoor map may also include information about room configurations, including for example furniture, fixture, and/or door placement. In some embodiments, the apparatus 10 may request a confirmation of the indoor map from a user. In some embodiments, the apparatus 10 may allow an indoor map to be modified after the indoor map has been generated. For example, the apparatus 10 may receive additional information relating to individual rooms that was not received before the generation of the indoor map.

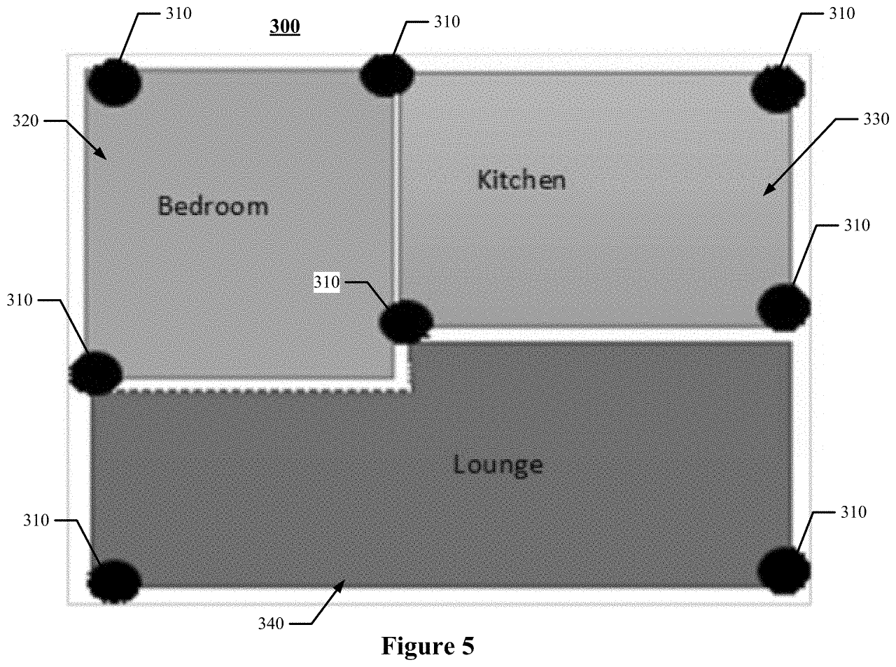

FIG. 5 illustrates an example indoor map of the area based on the overview map and the map creation information. As discussed in reference to FIGS. 3 and 4, the apparatus may be configured to determine the boundary, that is, the exterior shape and size of the area, in addition to the size, shape, and characteristics of individual rooms. In some embodiments, the apparatus 10 may be configured to combine the map creation information with the overview map (e.g. the overview map may provide an exterior boundaries of the area and the map creation information may be processed to generate information within the exterior boundaries, such as by defining the location and type of rooms within the area). For example, as shown in FIG. 5, based on the map creation information, the apparatus 10 of an example embodiment may determine that room 320 is a bedroom, room 330 is a kitchen, and room 340 is a lounge.

Referring now to optional Block 240 of FIG. 2, the apparatus 10 includes means, such as the processing circuitry 12, the processor 14, or the like, for causing the transmission of a prompt, such as an audible prompt and/or a visual prompt provided, for example, by a mobile device carried by a user, for room configuration information based on the specific type of room. In some embodiments, the prompt may be generic for a plurality of room types (e.g., “What is the size of the room?” or “Where are the doorways”). In other embodiments, the prompt may be specific based on the type of room (e.g., where is the toilet may only be asked in a bathroom). In some embodiments, the apparatus 10 may be configured to cause the transmission of a plurality of prompts for room configuration information. In some embodiments, the prompt may include options for answering. In some embodiments, the prompt may be based in part on the input from a previous prompt. In this regard, the prompts may follow a tree structure in which different prompts are generated depending upon the response to one or more prior prompts.

Referring now to optional Block 250 of FIG. 2, the apparatus 10 includes means, such as the processing circuitry 12, the processor 14, or the like, for receiving room configuration information based on the prompt. In some embodiments, the room configuration information may be received in the same way that the map creation information is received (e.g., via voice commands or via other forms of user input). In some embodiments, the apparatus 10 may receive location information related to the room configuration information. For example, the user may move to the location of a fixture, a piece of furniture, or a doorway based on the prompt. In such an example, the room configuration may be determined using the positioning system discussed above, which determines the position of the user or a mobile device carried by the user and, in turn, the location of the fixture, piece of furniture or doorway by which the user is standing. In some embodiments, the apparatus 10 may allow an input from a user without using the positioning system. For example, the user may input room configuration information into a mobile device, such as by clicking on a portion of the indoor map to indicate an aspect of the room configuration, such as the location of a particular object within the area.

Referring now to optional Block 260 of FIG. 2, the apparatus 10 includes means, such as the processing circuitry 12, the processor 14, or the like, for updating the indoor map of the area based on the room configuration information. In some embodiments, the indoor map may be populated with additional information relating to room configuration. In some embodiments, the apparatus 10 may generate a plurality of indoor maps for the same area based on the level of information included. For example, there may be one version of the indoor map, such as shown in FIG. 5, that provides on the map shape and room types and there may be additional versions of the indoor map that include more details, such as room size, room configuration, location of various objects within the room and/or the like. In some embodiments, the apparatus 10 may include means, such as the processing circuitry 12, e.g., the processor 14, for estimating room configuration based on the positioning of a room in relation to one or more other rooms. For example, kitchens may have a common layout in relation to a connecting living room. In some embodiments, the apparatus 10 may employ machine learning to predict the room configuration based on various factors of the current map and previous map configurations.

In an example embodiment, the steps discussed in Blocks 240 through 260 could be an iterative process. For example, upon determining that a room is a specific type (e.g., living room), the apparatus 10 may cause the transmission of a prompt asking about a specific room configuration feature. For example, in a living room, the apparatus 10 may request the user to answer, “Does this room have a couch?”. In such an example, if the user responds “yes”, then the apparatus 10 may be configured to request additional information about the couch, such as the size or position in the room. Alternatively, if the user responds “no”, then the apparatus 10 may be configured to request information about other potential features in the room, such as whether there is a television in the room. In some embodiments, the apparatus 10 includes means, such as the processing circuitry, e.g., the processor 14, for estimating information regarding one or more objects within a room configured based on room configuration information provided regarding other object(s) within the room. For example, the apparatus 10 may estimate the position of a television based on the position of a couch without any information being explicitly provided about the television. In some embodiments, the apparatus 10 may be configured to ask about the room type of a room based on the room type of adjacent room(s). For example, in an instance the apparatus 10 is in an unknown room, the apparatus 10 may cause the prompt of asking if the room is a kitchen based on the unknown room being adjacent to a living room.

### Example Use Case

In an example embodiment, the apparatus 10 may receive a verbal indication from a user that the user is located in the kitchen area. The apparatus 10 may request room configuration based on the type of room. For a kitchen, for example, the apparatus 10 may request the user locate the sink, at which point the user may move to the portion of the kitchen that the sink is located (e.g., the user may place a mobile device on the sink). The apparatus 10 may denote the location of the sink on the indoor map and then request for the location of subsequent objects (e.g., fixtures and/or furniture), such as a stove, a microwave, a refrigerator, and/or the like. Additionally, the apparatus 10 may request the location of other objects within the kitchen, such as the island, countertop, window, door, and/or the like. In some embodiments, the apparatus 10, such as the processing circuitry 12, e.g., the processor 14, may be configured to predict the location of one or more objects based on the location of another object (e.g., the sink may be located next to the dishwasher).

In some embodiments, the apparatus 10, such as the processing circuitry 12, may request one or more typical objects in a room. For example, the apparatus 10 may request the location of the sink, refrigerator, and stove in a kitchen. Additionally, the apparatus 10 may allow the user to input additional objects that may be in the space. For example, the apparatus 10 may provide a selectable list to the user of optional objects for the kitchen (e.g., an island, a toaster oven, a bar stool, a kitchen table). In some embodiments, the apparatus 10, such as the processing circuitry 12, may correlate objects with one another based on usage information (e.g., the map database may include the average usage rate of one or more objects in a given room type). In some embodiments, the apparatus 10 may be configured to request object locations based on a relationship with the optional object selected. For example, the apparatus 10 may request the location of a bar stool when a kitchen island is selected regardless of whether the bar stool was also selected due to bar stools often being included in kitchens that include a kitchen island.

Various methods, apparatus, and computer program products are provided in accordance with an example embodiment for generating an indoor map of an area. In an example embodiment, the apparatus 10 includes means, such as the communication interface 22, the processing circuitry 12, the processor 14, or the like, for receiving location information from a positioning system configured to determine the position of one or more components within the area. In such an example embodiment, the apparatus 10 includes means, such as the processing circuitry 12, e.g., the processor 14, for generating an overview map of the area. The overview map may define one or more boundaries of the area. In some embodiments, the apparatus 10 may include means, such as the processing circuitry 12, e.g., the processor 14, for receiving map creation information from a map creation asset, such as a user, configured to designate at least a subset of the area as a specific type of room. The apparatus 10 may also include means, such as the processing circuitry 12, e.g., the processor 14, for generating the indoor map of the area based on the overview map and the map creation information.

In an example embodiment, the apparatus 10 may further include means, such as the processing circuitry 12, e.g., the processor 14, for causing the transmission of a prompt for room configuration information based on the specific type of room. The apparatus 10 may still further include means, such as the communication interface 22, the processing circuitry 12, e.g., the processor 14, or the like, for receiving room configuration information based on the prompt. The apparatus 10 may also include means, such as the processing circuitry 12, e.g., the processor 14, for updating the indoor map of the area based on the room configuration information. Corresponding methods and computer program products are provided.

FIG. 2 illustrates a flowchart of an apparatus, method and computer program product according to example embodiments of the invention. It will be understood that each block of the flowchart, and combinations of blocks in the flowchart, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 16 of an apparatus 10 employing an embodiment of the present invention and executed by a processing circuitry 12 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included, some of which have been described above. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for generating an indoor map of an area, the method comprising:
receiving location information from a positioning system configured to determine a position of one or more components within the area;
generating an overview map of the area, wherein the overview map defines one or more boundaries of the area;
receiving map creation information from a map creation asset configured to designate at least a subset of the area as a specific type of room; and
generating the indoor map of the area based on the overview map and the map creation information.

2. The method according to claim 1 further comprising:
causing the transmission of a prompt for room configuration information based on the specific type of room;
receiving room configuration information based on the prompt; and
updating the indoor map of the area based on the room configuration information.

3. The method according to claim 1 wherein the positioning system comprises one or more ultra-wide band beacons configured to provide for radio-based positioning.

4. The method according to claim 3, wherein one of the one or more ultra-wide band beacons is designated as a primary beacon from which the coordinates of the one or more ultra-wide beacons are based.

5. The method according to claim 3 further comprising:
receiving a vertical dimension location of the beacon from at least one of a user input or a barometer; and
correlating map creation information and the overview map based on the vertical dimension location of the beacon.

6. The method according to claim 1, wherein the map creation information comprises voice assistance information.

7. The method according to claim 1, wherein the positioning system comprises at least one of a global navigation satellite system, a radio-based positioning, a camera-based system, or a hand drawing.

8. An apparatus for generating an indoor map of an area, the apparatus comprising at least one processor and at least one non-transitory memory including computer program code instructions, the computer program code instructions configured to, when executed, cause the apparatus to:
receive location information from a positioning system configured to determine a position of one or more components within the area;
generate an overview map of the area, wherein the overview map defines one or more boundaries of the area;
receive map creation information from a map creation asset configured to designate at least a subset of the area as a specific type of room; and
generate the indoor map of the area based on the overview map and the map creation information.

9. The apparatus according to claim 8, wherein the at least one memory and computer program code are configured to, with the processor, cause the apparatus to:
cause the transmission of a prompt for room configuration information based on the specific type of room;
receive room configuration information based on the prompt; and
update the indoor map of the area based on the room configuration information.

10. The apparatus according to claim 8, wherein the positioning system comprises one or more ultra-wide band beacons configured to provide radio-based positioning.

11. The apparatus according to claim 10, wherein one of the one or more ultra-wide band beacons is designated as a primary beacon from which the coordinates of the one or more ultra-wide beacons are based.

12. The apparatus according to claim 10, wherein the at least one memory and computer program code are configured to, with the processor, cause the apparatus to:
receive vertical dimension location of the beacon from at least one of a user input or a barometer; and
correlate map creation information and the overview map based on the vertical dimension location of the beacon.

13. The apparatus according to claim 8, wherein the map creation information comprises voice assistance information.

14. The apparatus according to claim 8, wherein the positioning system comprises at least one of a global navigation satellite system, a radio-based positioning, a camera-based system, or a hand drawing.

15. A computer program product comprising at least one non-transitory computer-readable storage medium having computer-executable program code portions stored therein, the computer-executable program code portions comprising program code instructions configured to:
receive location information from a positioning system configured to determine a position of one or more components within the area;
generate an overview map of the area, wherein the overview map defines one or more boundaries of the area;
receive map creation information from a map creation asset configured to designate a subset of the area as a specific type of room; and
generate the indoor map of the area based on the overview map and the map creation information.

16. The computer program product according to claim 15 further comprising program code instructions to:
cause the transmission of a prompt for room configuration information based on the specific type of room;
receive room configuration information based on the prompt; and
update the indoor map of the area based on the room configuration information.

17. The computer program product according to claim 15, wherein the positioning system comprises one or more ultra-wide band beacons configured to provide radio-based positioning.

18. The computer program product according to claim 17 further comprising program code instructions to:
receive vertical dimension location of the beacon from at least one of a user input or a barometer; and
correlate map creation information and the overview map based on the vertical dimension location of the beacon.

19. The computer program product according to claim 15, wherein the map creation information comprises voice assistance information.

20. The computer program product according to claim 15, wherein the positioning system comprises at least one of a global navigation satellite system, a radio-based positioning, a camera-based system, or a hand drawing.
